(19) United States
(12) Patent Application Publication
(10) Pub. No.: US 2026/0321950 A1
(43) Pub. Date: Oct. 15, 2026

(54) WIDEBAND QUADRATURE COUPLER FOR HIGH RADIO FREQUENCY APPLICATIONS

(71) Applicant: Dell Products L.P., Round Rock, TX (US)

(72) Inventors: Tejinder Singh, Manotick (CA); Navjot Kaur Khaira, Manotick (CA)

(21) Appl. No.: 19/175,890

(22) Filed: Apr. 10, 2025

(51) Int. Cl. H01P 5/12; H01P 3/08

(52) U.S. Cl. CPC H01P 5/12; H01P 3/08

(57) ABSTRACT

The technology described herein is directed towards a wideband quadrature coupler suitable for high radio frequency (RF) signals, such as Wi-Fi and 5G signals. In one implementation, the wideband quadrature coupler is based on a three-metal layer design with a topology based on branch-line coupler theory. The primary transmission lines in one layer (e.g., an upper metal layer) are tapered, enabling dynamic impedance transformation as the signal progresses towards a tapered junction between serpentine impedance transformers, including additional impedance transformers, facilitating consistent performance and phase balance. The stepped impedance transformation also facilitates broader operational bandwidth and enhances performance consistency across frequencies. The other metal layers are configured to enhance desired coupling between RF ports. The additional layers also help to mitigate unwanted parasitic capacitance by their routing.

### BACKGROUND

Quadrature couplers are components used in radio frequency (RF) systems, facilitating the efficient division and combination of signals with precise phase relationships. They are commonly used for applications such as signal splitting, mixing, and beamforming in RF communication systems. Common types of such couplers include branch-line couplers, Lange couplers, and hybrid couplers. Each type is characterized by its compactness, bandwidth, and phase accuracy, with trade-offs in design complexity and performance.

Quadrature couplers are also used in Wi-Fi systems for power division in antennas, combining signals in beamforming networks, phase shifting, and implementing modulation and demodulation in transceivers, while being able to improve signal integrity and achieve high data rates in advanced Wi-Fi technologies. Wideband couplers operate across broad frequency ranges, useful for multiband systems, while narrowband couplers are designed for specific frequency ranges, offering high performance with respect to insertion loss, isolation, and phase accuracy; narrowband couplers are commonly used in single-band applications like Wi-Fi transceivers or dedicated RF channels.

### BRIEF DESCRIPTION OF THE DRAWINGS

The technology described herein is illustrated by way of example and not limited in the accompanying figures in which like reference numerals indicate similar elements and in which:

FIG. 1 is top view representation of a layout of an example multilayered quadrature coupler for radio frequency (RF) signals, showing metal layers and interconnects, in accordance with various embodiments and implementations of the subject disclosure.

FIG. 2 is top view representation of the example multilayered quadrature coupler of FIG. 1 showing the various metal layers including primary and shunt transmission lines, in accordance with various embodiments and implementations of the subject disclosure.

FIG. 3 is a circuit representation of an example wideband quadrature coupler showing additional impedance transformers for RF matching, in accordance with various embodiments and implementations of the subject disclosure.

FIG. 4 is a three-dimensional (3D) perspective top view corresponding to the example multilayered quadrature coupler of FIG. 1 deployed as a device on a substrate, in accordance with various embodiments and implementations of the subject disclosure.

FIG. 5 is zoomed in three-dimensional (3D) perspective top view of a portion of an example multilayered quadrature coupler highlighting the various metal layers, in accordance with various embodiments and implementations of the subject disclosure.

FIG. 6 is top view representation of an example multilayered quadrature coupler showing fine tuning of impedance via different dimensions of impedance transformers in the primary transmission lines, and electromagnetic (EM) coupling to enhance bandwidth, in accordance with various embodiments and implementations of the subject disclosure.

FIG. 7 is a top view representation of a zoomed-in portion of FIG. 6, in accordance with various embodiments and implementations of the subject disclosure.

FIG. 8 is a graphical representation of simulated response of the example quadrature coupler designed with around a 4 GHz bandwidth and around a 6 GHz center frequency, showing S-parameter magnitudes for a range of frequencies, in accordance with various example embodiments and implementations of the subject disclosure.

FIG. 9 is a graphical representation of simulated response of the example quadrature coupler designed with around a 4 GHz bandwidth and around a 6 GHz center frequency, showing phase response in degrees for a range of frequencies, in accordance with various example embodiments and implementations of the subject disclosure.

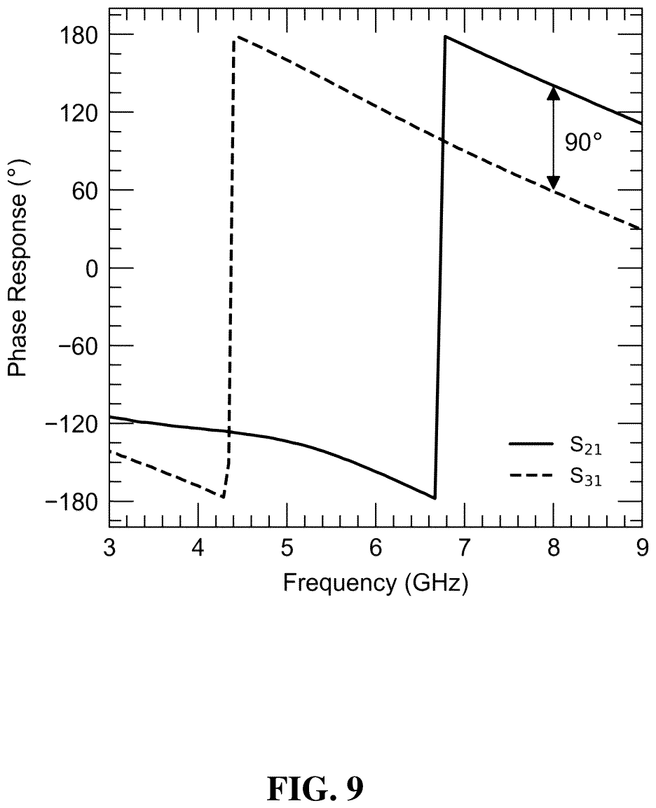

FIG. 10 is a representation of a schematic/block diagram of a Butler matrix beamforming network that includes example quadrature couplers as described herein, in accordance with various example embodiments and implementations of the subject disclosure.

### DETAILED DESCRIPTION

The technology described herein is generally directed towards a wideband hybrid coupler configured in a multilayer topology, with one metal layer for the primary transmission lines between the radio frequency (RF) ports, and additional metal layers to enhance coupling, reduce parasitic capacitance, and extend bandwidth. Tapered primary transmission lines facilitate dynamic impedance transformation, resulting in consistent performance and phase balance.

The multilayer topology is based on the well-established branch-line coupler theory, enhanced with improved coupling and impedance matching achieved by precise trimming of line lengths. Additionally, the primary transmission lines in the design are tapered, enabling dynamic impedance transformation as the signal progresses towards the junction. This stepped impedance transformation contributes to the broader operational bandwidth and enhances performance consistency across frequencies.

Note that as wireless systems adopt higher frequencies like Wi-Fi 7/8 and 5G-NR (fifth generation-new radio), conventional hybrid couplers face challenges such as narrow bandwidth, high insertion loss, and degraded phase balance. More particularly, the higher frequencies of Wi-Fi 7/8 and 5G-NR present challenges for RF components, particularly hybrid couplers, which are used for phase-sensitive applications. Traditional hybrid couplers, including microstrip, strip line, and waveguide-based designs, face challenges such as narrow bandwidth, high insertion loss, degraded phase balance and bulky structures, limiting their performance and suitability at these frequencies. Reduced wavelengths exacerbate parasitics and fabrication tolerances, hindering scalability and efficiency in next-generation wireless systems. For a conventional microstrip configuration, both the series and shunt branches of the device have to have a length of λ/4, and while such implementation approach is straightforward, it presents a significant limitation regarding bandwidth, in part because the line lengths achieve λ/4 only at a specific frequency. Commercially available couplers also are often expensive, which can significantly increase the cost of the systems in which they are used. Commercially available couplers are also bulky, whereby if a system needs multiple couplers, the size and weight limitation pose implementation challenges. Other types of couplers face challenges with fabrication complexity, cost, and integration with planar circuits. Maintaining wide bandwidth and consistent performance at high frequencies remains an obstacle among any of the traditional coupler approaches.

The technology described herein addresses these issues via a multilayered wideband quadrature coupler as in the examples herein, with a design compatible with standard printed circuit board manufacturing techniques. One such design features a three-layer topology with the additional metal layers to enhance coupling, reduce parasitic capacitance, and extend bandwidth. Tapered primary lines enable dynamic impedance transformation, ensuring more consistent performance and phase balance, making this approach suitable for next-generation wireless communication systems such as Wi-Fi and 5G-NR RF communications.

It should be understood that any of the examples and/or descriptions herein are non-limiting. Thus, any of the embodiments, example embodiments, concepts, structures, functionalities or examples described herein are non-limiting, and the technology may be used in various ways that provide benefits and advantages in communications and computing in general.

Reference throughout this specification to “one embodiment,” “an embodiment,” “one implementation,” “an implementation,” etc. means that a particular feature, structure, characteristic and/or attribute described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, characteristics and/or attributes may be combined in any suitable manner in one or more embodiments/implementations. Repetitive description of like elements employed in respective embodiments may be omitted for sake of brevity.

The detailed description is merely illustrative and is not intended to limit embodiments and/or application or uses of embodiments. Furthermore, there is no intention to be bound by any expressed or implied information presented in the preceding sections, or in the Detailed Description section. Further, it is to be understood that the present disclosure will be described in terms of a given illustrative architecture; however, other architectures, structures, materials and process features, and steps can be varied within the scope of the present disclosure.

It also should be noted that terms used herein, such as “optimize,” “optimization,” “optimal,” “optimally” and the like only represent objectives to move towards a more optimal state, rather than necessarily obtaining ideal results. For example, “optimal” placement of a subnet means selecting a more optimal subnet over another option, rather than necessarily achieving an optimal result. Similarly, “maximize” means moving towards a maximal state (e.g., up to some processing capacity limit), not necessarily achieving such a state, and so on.

It will also be understood that when an element such as a layer, region or substrate is referred to as being “on” or “over” “atop” “above” “beneath” “below” “between” and so forth with respect to another element, it can be directly on the other element or intervening elements can also be present. In contrast, only if and when an element is referred to as being “directly on” or “directly over” another element, are there no intervening element(s) present. Note that orientation is generally relative; e.g., “on” or “over” can be flipped, and if so, can be considered unchanged, even if technically appearing to be under or below/beneath when represented in a flipped orientation. It will also be understood that when an element is referred to as being “connected” or “coupled” to another element, it can be directly connected or coupled to the other element or intervening elements can be present. In contrast, only if and when an element is referred to as being “directly connected” or “directly coupled” to another element, are there no intervening element(s) present.

The following detailed description is merely illustrative and is not intended to limit embodiments and/or application or uses of embodiments. Furthermore, there is no intention to be bound by any expressed or implied information presented in the preceding sections, or in the Detailed Description section.

One or more example embodiments are now described with reference to the drawings, in which example components, graphs and/or operations are shown, and in which like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details, and that the subject disclosure may be embodied in many different forms and should not be construed as limited to the examples set forth herein.

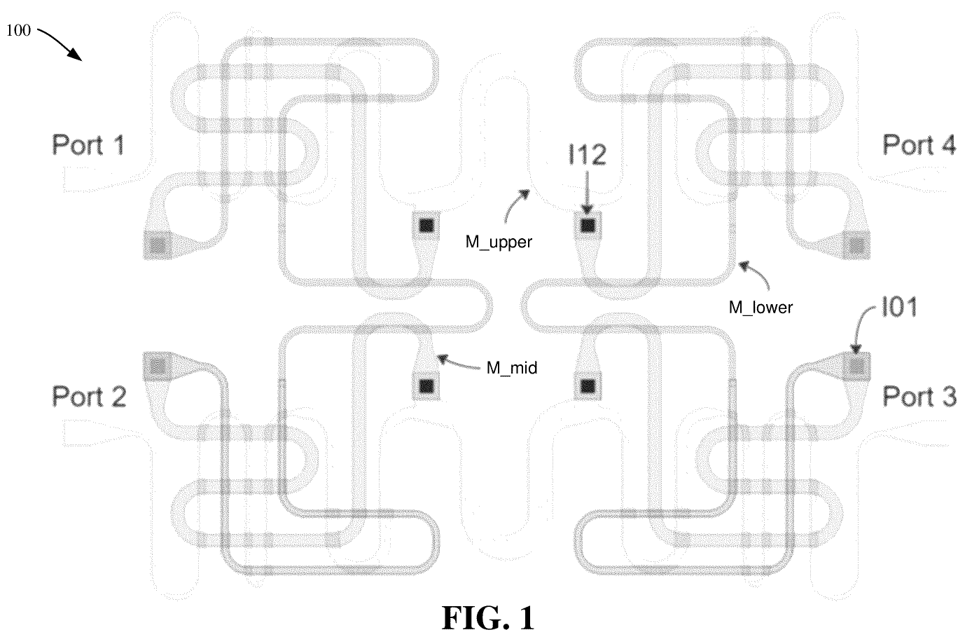

FIG. 1 shows a top view of an example wideband quadrature coupler 100 including a top metal layer M_upper, a middle metal layer M_mid, and a bottom metal layer M_lower. In this example implementation, the top metal layer M_upper includes the primary transmission lines that couple RF signals between the ports, which in this example is from Port 1 (input port) to Port 4 (through port), with Port 3 (coupled port) receiving a phase shifted (e.g., typically ninety degrees) instance of the RF signals obtained at Port 4. Port 2 is the isolated port that is typically terminated. Also shown in FIG. 1 are two sets of interconnects, including one interconnect set that interconnects the bottom metal layer M_lower to the middle metal layer M_mid, (e.g., one of which is labeled 101), and another interconnect set that interconnects the middle metal layer M_mid to the top metal layer M_upper (e.g., one of which is labeled I12). It should be noted that the example implementation of FIG. 1 can have a different ordering of the three layers, e.g., a similar multilayer wideband quadrature coupler configured as described herein is not limited to having the primary transmission lines on the top metal layer, for example.

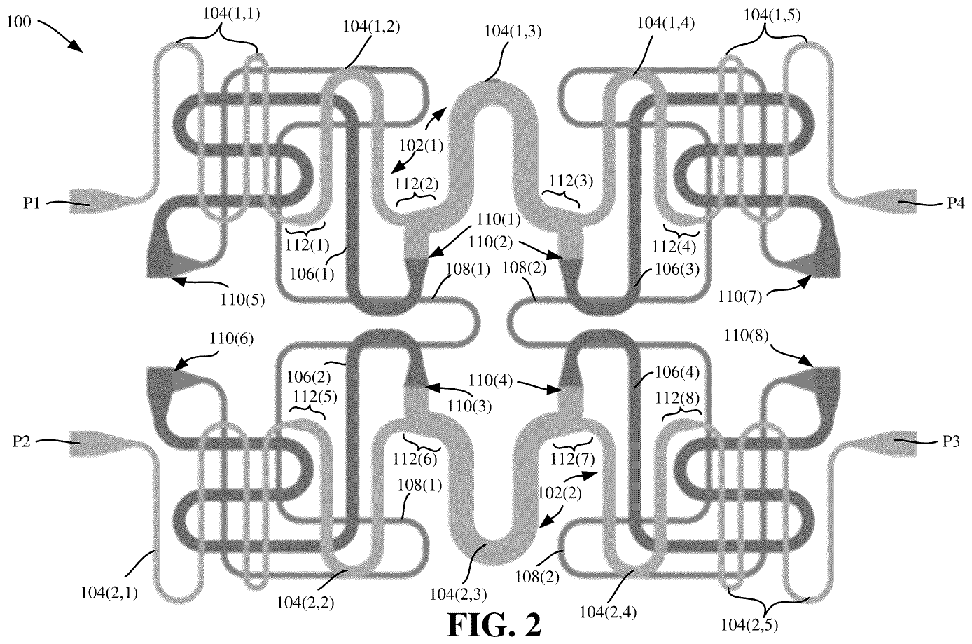

FIG. 2 shows the various transmission lines coupled to ports P1-P4 of the example wideband quadrature coupler 100, along with the other metal layers. The transmission lines include two primary transmission lines 102(1) and 102(2) implemented in the top layer in this example, and shunt transmission lines. In one implementation the primary transmission lines 102(1) and 102(2) are configured in serpentine patterns of impedance transformers 104(1, 1)-104(1, 5) and 104(2, 1)-104(2, 5). The shunt transmission lines include impedance transformers divided into four shunt transmission lines 106(1)-106(4) (metal lines coupled together in pairs) implemented in the middle layer in this example. The lower metal layer, which can be considered part of the shunt transmission lines via coupling thereto, is divided into two sections 108(1) and 108(2), shown on the left and right sides of FIG. 2, respectively.

A first set of interconnects 110(1)-110(4) couple the primary transmission lines 102(1) and 102(2) to the shunt transmission lines 106(1)-106(4), and a second set of interconnects 110(5)-110(8) couple the shunt transmission lines 106(1)-106(4) to the two lower-layer sections 108(1) and 108(2). More particularly, the interconnects 110(1) and 110(2) electrically couple the first primary transmission line 104(1) to the shunt transmission lines 106(1) and 106(3), respectively, while the interconnects 110(3) and 110(4) electrically couple the second primary transmission line 104(2) to the shunt transmission lines 106(2) and 106(4). The interconnects 110(5) and 110(6) electrically couple the shunt transmission lines 106(1) and 106(2) to opposite ends of the first lower metal layer section 108(1), respectively. The interconnects 110(7) and 110(8) electrically couple the shunt transmission lines 106(3) and 106(4) to opposite ends of the second lower metal layer section 108(2), respectively.

The first primary transmission line 102(1) includes five stepped impedance transformers 104(1, 1)-104(1, 5), and the second primary transmission line 102(2) includes five stepped impedance transformers 104(2, 1)-104(2, 5). In general, for the first primary transmission line 102(1), a first outer impedance transformer 104(1, 1) couples to the port P1 at one end, and to a first inner impedance transformer 104(1, 2) at its opposite end. In turn, the inner impedance transformer 104(1, 2) is coupled to a central impedance transformer 104(1, 2). The other end of the central impedance transformer 104(1, 3) is coupled to a second inner impedance transformer 104(1, 4) that is coupled at its other end to a second outer impedance transformer 104(1, 5) coupled to the port P4 at its other end. The second primary transmission line 102(2) has a similar arrangement of impedance transformers between the port P2 and the port P3, and these are not again described in detail for purposes of brevity.

In one implementation, the impedance transformers 104(1, 1)-104(1, 5) and 104(2, 1)-104(2, 5) are stepped. For example, the first primary transmission line 102(1) can have a narrower width for the first outer impedance transformer 104(1, 1), a medium width for the first inner impedance transformer 104(1, 2), a wider width for the central impedance transformer 104(1, 3), a medium width for the second inner impedance transformer 104(1, 4), and a narrower width for the second outer impedance transformer 104(1, 5). The same width relationships can exist in the impedance transformers 104(2, 1)-104(2, 5) of the second primary transmission line 102(2). As shown in FIG. 2, the junctions of these couplings are tapered in one implementation, shown as tapered junctions 112(1)-112(4) for the first primary transmission line 102(1), and tapered junctions 112(5)-112(8) for the second primary transmission line 102(2).

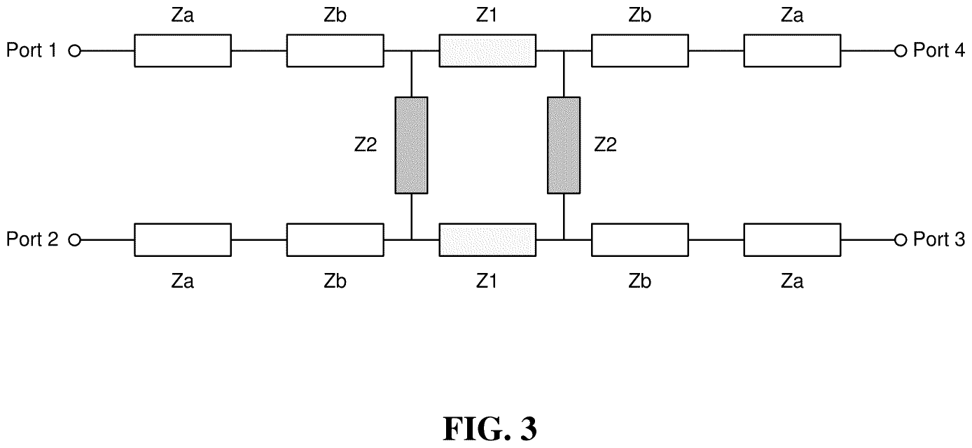

FIG. 3 shows a general concept of the example wideband quadrature coupler in a circuit diagram. Compared to conventional lines, the example wideband quadrature coupler described herein includes additional impedance transformers for RF matching, including impedance transformers having the impedances Za and Zb. In this example, corresponding to an implementation of FIG. 2, the design has symmetrically arranged impedance values in both of the primary lines 102(1) and 102(2), shown as Za, Zb, Z1, Zb and Za. The shunt impedance transformers have the same impedance, Z2. The impedances Z1, Z2, Z2 and Z1 correspond to a branch-line ring composed of RF microstrips; the Z1 impedances correspond to the central impedance transformers 104(1, 3) and 104(2, 3), and the Z2 impedances correspond to the two pairs of shunt transmission lines 106(1), 106(2) and 106(3), 106(4).

Coupling is determined by the equations:

$${Z}_{1} = {Z}_{0} \sqrt{1 - {k}^{2}} and$$

$${Z}_{2} = {Z}_{0} \sqrt{\frac{1}{{k}^{2}} - 1}$$

where k is the coupling coefficient and Z₀ is the characteristic impedance (e.g., 50 ohms). Z₁ equals 70.7 percent of Z₂. For a wideband flat response, Za is chosen to equal 87.6 ohms, and Zb to equal 84.3 ohms.

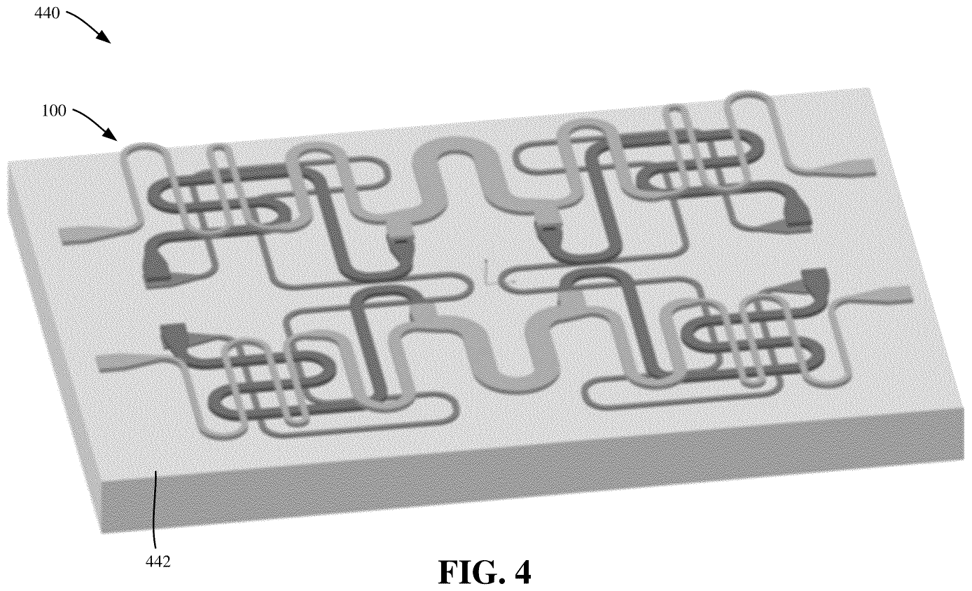

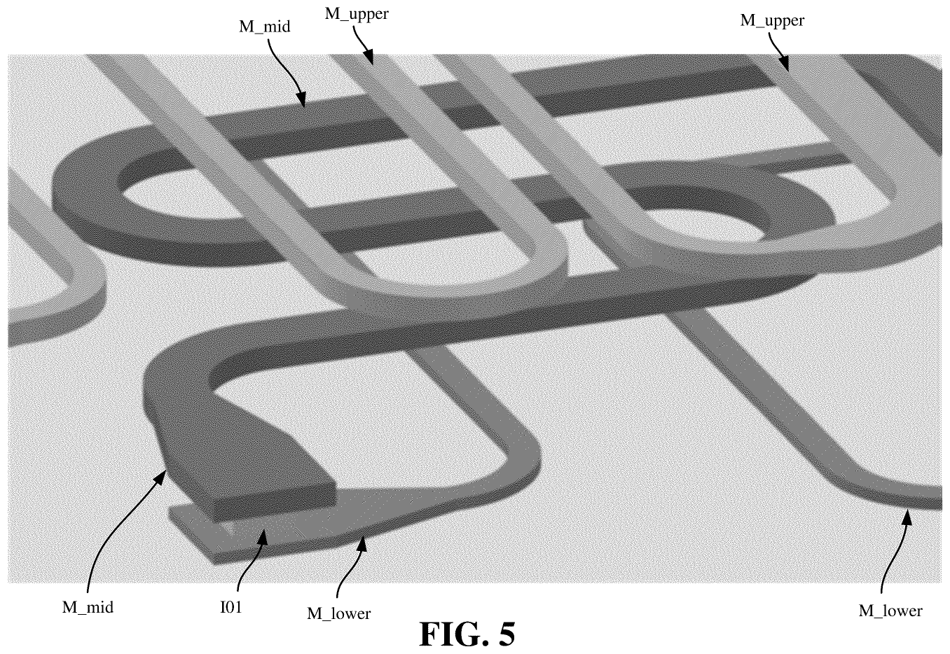

FIG. 4 shows a 3D view of a device 440 including the wideband quadrature coupler 100 atop a substrate 442. FIG. 5 shows a zoomed in portion of the device 440 of FIG. 4, in which a portion of the upper metal layer M_upper is above a portion of the middle metal layer M_mid, which is above a portion of the lower metal layer M_lower. One of the interconnects that electrically couples the middle metal layer M_mid and the lower metal layer M_lower is visible, labeled 101. Although not explicitly shown in FIG. 4, there can be a dielectric between each metal layer.

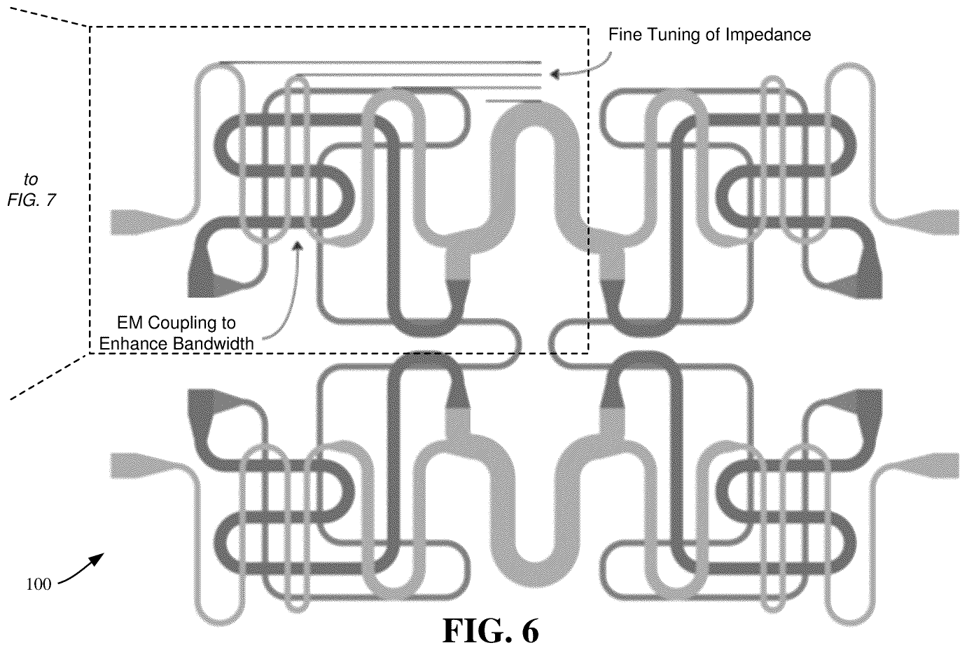

FIG. 6 shows the example wideband quadrature coupler 100, in which EM coupling between the various layered metal overlays, at the locations where they are designed to strategically overlap to enhance coupling between the layers, significantly widening the operational bandwidth. The layers also mitigate unwanted parasitic capacitances through designed routing, thereby improving the overall efficiency and reliability of the quadrature coupler device.

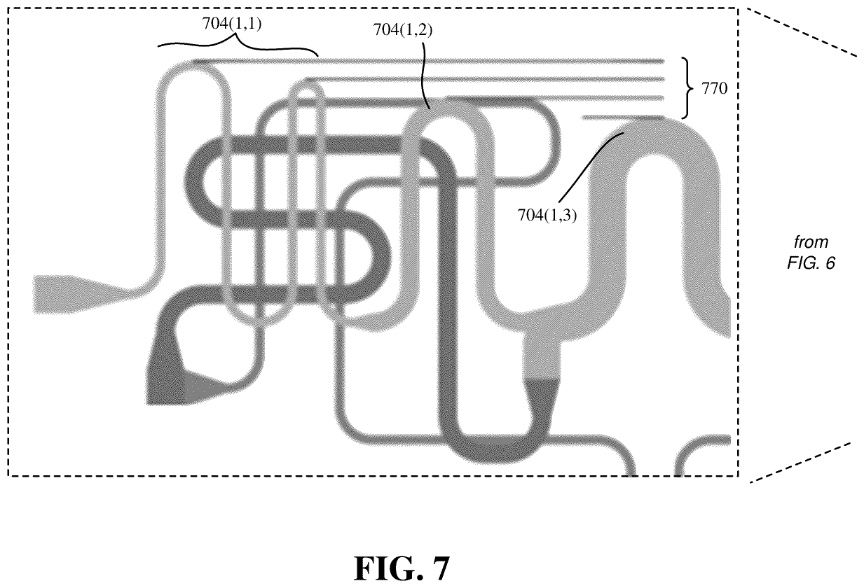

Further, FIG. 7 shows a zoomed in view of the four lines 770 (identified as “Fine Tuning of Impedance” in FIG. 6) which represent the heights and illustrate their height differences of three of the serpentine impedance transformers (outer, inner and central) 704(1, 1)-704(1, 3). By changing one or more of the heights during design, one or more of the height differences correspondingly change relative to one another and change one or more of the lengths of the impedance transformers, thereby fine tuning the impedance. It should be understood that similar dimension changes can also be made to the one or more of the other metal layers to tune the shunt impedances.

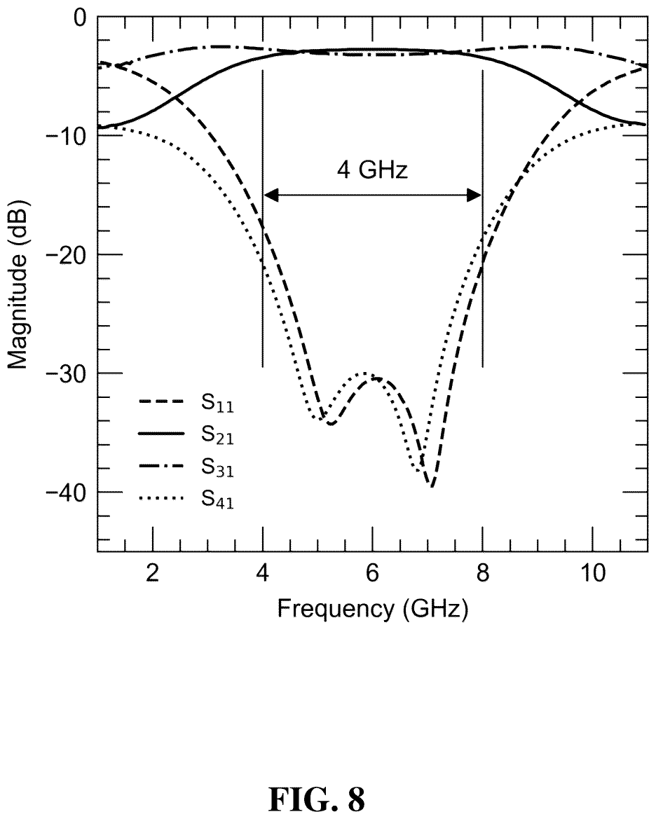

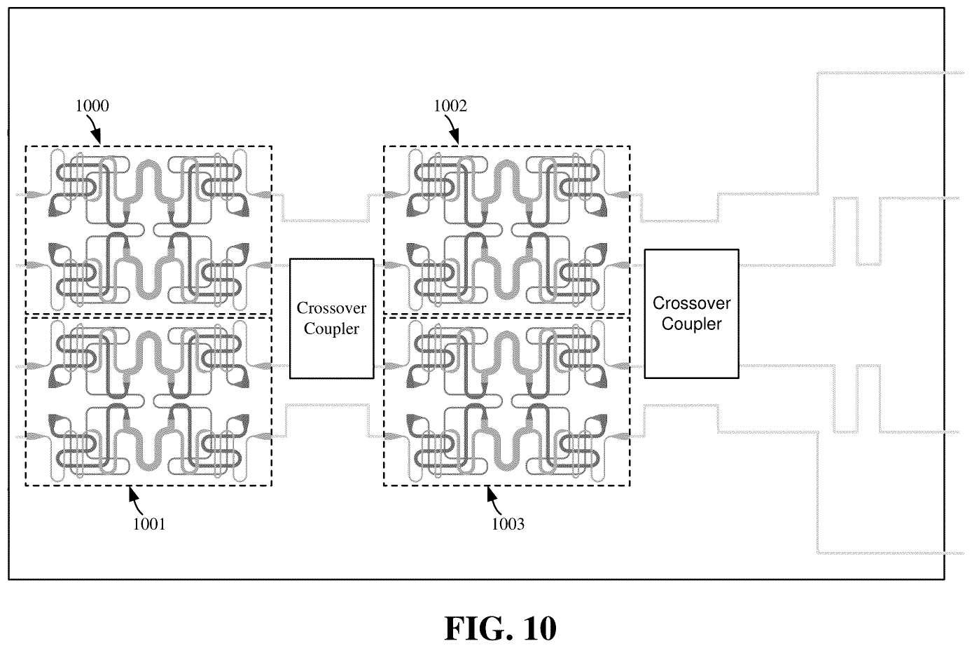

Metrics for couplers include insertion loss, phase accuracy (e.g., maintaining precise 90 degrees phase difference between outputs), coupling factor, and isolation (minimizing signal leakage between ports). FIG. 8 is a graphical representation of simulated response of the example quadrature coupler generally designed based on a 4 GHz bandwidth a 6 GHz center frequency. FIG. 8 shows the magnitudes (in dB) of the S-parameters S₁₁, S₂₁, S₃₁ and S₄₁ for a frequency range from below 2 GHz to above 10 GHz. FIG. 10 is a graphical representation of simulated phase response of the example quadrature coupler in degrees) (° for the same design over the same frequency range, showing a phase difference between S₂₁ and S₃₁.

With respect to quadrature coupler uses, in high frequency communication systems, quadrature couplers based on the example design described herein can be used in a Butler matrix. The example of FIG. 10 shows four quadrature couplers 1000-1003 as described herein incorporated into a Butler matrix beamforming network.

To summarize, the wideband quadrature coupler described herein leverages a straightforward three-layer design that is compatible with standard manufacturing processes, making the wideband quadrature coupler cost-effective and scalable for modern applications. The design incorporates precise impedance calculations to facilitate optimal performance, and employs second and third metal layers to enhance coupling between layers, significantly widening the operational bandwidth.

One or more example embodiments can be embodied in a quadrature coupler, such as described and represented herein. The quadrature coupler can include a first radio frequency (RF) port, a second RF port, a third RF port, a fourth RF port an upper metal layer, a lower metal layer, and a middle metal layer between the upper metal layer and the lower metal layer. The quadrature coupler can include a first set of interconnects that couple the first metal layer to the second metal layer, and a second set of interconnects that couple the second metal layer to the third metal layer. The upper metal layer can be configured with respective primary transmission lines including a respective first primary transmission line between the first RF port and the fourth RF port, and a respective second primary transmission line between the second RF port and the third RF port. The respective primary transmission lines can include respective first RF impedance transformers having respective first impedances, respective second RF impedance transformers having respective second impedances, respective third RF impedance transformers having respective third impedances, respective fourth RF impedance transformers having respective fourth impedances, and respective fifth RF impedance transformers having respective fifth impedances, wherein the respective second RF impedance transformers are between the respective first RF impedance transformers and the respective third RF impedance transformers, and wherein the respective fourth RF impedance transformers are between the respective third RF impedance transformers and the respective fifth RF impedance transformers. The middle metal layer can be configured with respective shunt transmission lines including a first shunt transmission line, a second shunt transmission line, a third shunt transmission line, and a fourth shunt transmission line. The first shunt transmission line can be coupled to the respective first primary transmission line via a first interconnect of the first set of interconnects, the second shunt transmission line can be coupled to the respective first primary transmission line via a second interconnect of the first set of interconnects, the third shunt transmission line can be coupled to the respective second primary transmission line via a third interconnect of the first set of interconnects, and the fourth shunt transmission line can be coupled to the respective second primary transmission line via fourth interconnect of the first set of interconnects. The lower metal layer can be configured with respective sections including a first section and a second section, the first section can be coupled to the first shunt transmission line via a fifth interconnect of the second set of interconnects, the first section can be coupled to the second shunt transmission line via a sixth interconnect of the second set of interconnects, the second section can be coupled to the third shunt transmission line via a seventh interconnect of the second set of interconnects, and the second section can be coupled to the fourth shunt transmission line via an eighth interconnect of the second set of interconnects. The first shunt transmission line can be RF coupled to the second shunt transmission line, and electrically coupled to the second shunt transmission line via the first section, to result in a first shunt impedance between the first primary transmission line and the second primary transmission line. The third shunt transmission line can be RF coupled to the fourth shunt transmission line, and electrically coupled to the fourth shunt transmission line via the second section, to result in a second shunt impedance between the first primary transmission line and the second primary transmission line.

The first impedance can equal the fifth impedance.

The second impedance can equal the fourth impedance.

The first impedance can equal the fifth impedance, and the second impedance can equal the fourth impedance.

The first shunt impedance can equal the second shunt impedance.

The respective first primary transmission line can be configured in a serpentine pattern in which the respective first impedance transformer and the respective second impedance transformer can be above and RF coupled to the first shunt transmission line, and in which the respective fourth impedance transformer and the respective fifth impedance transformer can be above and RF coupled to the second shunt transmission line.

The first interconnect of the first set of interconnects can couple the respective first primary transmission line of the respective primary transmission lines to the first shunt transmission line between the respective second impedance transformer and the respective third impedance transformer of the respective first primary transmission line, the second interconnect of the first set of interconnects can couple the respective first primary transmission line to the third shunt transmission line between the respective third impedance transformer and the respective fourth impedance transformer of the respective first primary transmission line, the third interconnect of the first set of interconnects can couple the respective second primary transmission line to the second shunt transmission line between the respective second impedance transformer and the respective third impedance transformer of the respective second primary transmission line, and the fourth interconnect of the first set of interconnects can couple the respective second primary transmission line to the fourth shunt transmission line between the respective third impedance transformer and the respective fourth impedance transformer of the respective second primary transmission line.

The respective third impedance of the respective first primary transmission line, the respective third impedance of the respective second primary transmission line, the first shunt impedance, and the second shunt impedance can correspond to a branch-line ring configuration.

The respective first impedance transformer of the respective first primary transmission line can be narrower than the respective second impedance transformer of the respective first primary transmission line, the respective second impedance transformer of the respective first primary transmission line can be narrower than the respective third impedance transformer of the respective first primary transmission line, and the respective first primary transmission line can include a first tapered portion that can couple the respective first impedance transformer to the respective second impedance transformer, and a second tapered portion that can couple the respective second impedance transformer to the respective third impedance transformer.

The respective first impedance transformer of the respective first primary transmission line can include a first serpentine curve having a first height, and a second serpentine curve having a second height that can be less than the first height; the respective second impedance transformer of the respective first primary transmission line can include a third serpentine curve having a third height that can be less than the second height; the respective third impedance transformer of the respective first primary transmission line can include a fourth serpentine curve having a fourth height that can be less than the third height, and a combined impedance of the respective first primary transmission line can be based on a first difference between the first height and the second height, a second difference between the second height and the third height, and a third difference between the third height and the fourth height.

The second primary transmission line can be configured to mirror the first primary transmission line, the first shunt transmission line can be configured to mirror the second shunt transmission line, and to mirror the third shunt transmission line, the fourth shunt transmission line can be configured to mirror the second shunt transmission line, and to mirror the third shunt transmission line, and the first section can be configured to mirror the second section.

One or more example embodiments can be embodied in a quadrature coupler, such as described and represented herein. The quadrature coupler can include an upper metal layer including a first primary transmission line between a first radio frequency (RF) port and a fourth RF port, and a second primary transmission line between a second RF port and a third RF port, a middle metal layer including shunt transmission lines electrically coupled to the upper metal layer, and RF coupled to the upper metal layer, the shunt transmission lines configured to RF couple the first primary transmission line to the second primary transmission line, and a lower metal layer including sections electrically coupled to the middle metal layer, and RF coupled to the middle metal layer; the shunt transmission lines can be configured to electrically couple the first primary transmission line to the second primary transmission line via the sections of the lower metal layer. A first portion of the first primary transmission line can correspond to a first impedance, a second portion of the second primary transmission line can correspond to the first impedance, a first set of the shunt transmission lines can correspond to a second impedance, and a second set of the shunt transmission lines can correspond to the second impedance. The first impedance of the first primary transmission line, the first impedance of the second primary transmission line, the second impedance of the first set of the shunt transmission lines, and the second impedance of the second set of the shunt transmission lines can correspond to a branch-line ring configuration that outputs an RF signal obtained at the first port to the fourth RF port, and outputs a phase-shifted instance of the RF signal obtained at the first port to the third RF port.

The shunt transmission lines can be electrically coupled to the upper metal layer via a first set of interconnects, and wherein the lower metal layer can be electrically coupled to the middle metal layer via a second set of interconnects.

The first primary transmission line can be configured in a serpentine shape of impedance transformers configured as curved portions of the serpentine shape, the first portion of the first primary transmission line can include a central impedance transformer, and the first primary transmission line can include a first outer impedance transformer coupled to the first RF port, a second outer impedance transformer coupled to the fourth RF port, a first inner impedance transformer coupled between the first outer impedance transformer and the central impedance transformer, and a second inner impedance transformer coupled between the central impedance transformer and the first outer impedance transformer.

The first outer impedance transformer can have a first width, the first inner impedance transformer can have a second width that can be different from the first width, the central impedance transformer can have a third width that can be different from the second width, the first outer impedance transformer can be electrically coupled to the first inner impedance transformer by a first tapered coupling, and the first inner impedance transformer can be electrically coupled to the central impedance transformer by a second tapered coupling.

The first outer impedance transformer can have a first line length, the first inner impedance transformer can have a second line length that can be different from the first line length, the central impedance transformer can have a third line length that can be different from the second line length, and a combined impedance of the first primary transmission line can be based on a first difference between the first line length and the second line length, and a second difference between the second line length and the third line length.

The serpentine shape can be a first serpentine shape, the first set of the shunt transmission lines can include a first part of the middle metal layer configured in a second serpentine shape that can overlap the first outer impedance transformer and the first inner impedance transformer, the sections of the lower metal layer can include a first section and a second section, and the second serpentine shape can overlap at least part of the first section of the lower metal layer.

One or more example embodiments can be embodied in a device, such as described and represented herein. The device can include a wideband quadrature coupler configured to output a radio frequency (RF) signal obtained at a first RF port to a fourth RF port, and output a phase shifted instance of the RF signal to a third RF port. The wideband quadrature coupler can include a first primary transmission line on a first metal layer, the first primary transmission line including a first outer impedance transformer coupled to the first RF port, a first inner impedance transformer, a first central impedance transformer, a second inner impedance transformer, and a second outer impedance transformer coupled to the fourth RF port. The first inner impedance transformer can be electrically coupled between the first outer impedance transformer and the first central impedance transformer, and the second inner impedance transformer can be electrically coupled between the first central impedance transformer and the second outer impedance transformer. The device can include a second primary transmission line on the first metal layer, the second primary transmission line can include a third outer impedance transformer coupled to a second RF port, a third inner impedance transformer, a second central impedance transformer, a fourth inner impedance transformer, and a fourth outer impedance transformer coupled to the third RF port. The third inner impedance transformer can be electrically coupled between the third outer impedance transformer and the second central impedance transformer, and the fourth inner impedance transformer can be electrically coupled between the second central impedance transformer and the fourth outer impedance transformer. The device can include a second metal layer, which can include a first shunt transmission line electrically coupled between the first inner impedance transformer and the first central impedance transformer, and RF coupled to the first outer impedance transformer and the first inner impedance transformer, a second shunt transmission line electrically coupled between the first central impedance transformer and the second inner impedance transformer, and RF coupled to the second inner impedance transformer and the second outer impedance transformer, a third shunt transmission line electrically coupled between the third inner impedance transformer and the second central impedance transformer, and RF coupled to the third outer impedance transformer and the third inner impedance transformer, and a fourth shunt transmission line electrically coupled between the second central impedance transformer and the fourth inner impedance transformer, and RF coupled to the fourth outer impedance transformer and the fourth outer inner impedance transformer. The device can include a third metal layer that can include a first section electrically coupled between the first shunt transmission line and the second shunt transmission line, wherein the first section can be RF coupled to the first shunt transmission line, and RF coupled to the third shunt transmission line, and a second section electrically coupled between the third shunt transmission line and the fourth shunt transmission line, wherein the first section can be RF coupled to the second shunt transmission line, and RF coupled to the fourth shunt transmission line. The first primary transmission line can be electrically coupled to the second primary transmission line via the first section being electrically coupled to the first shunt transmission line and being electrically coupled to the second shunt transmission line, and via the second section being electrically coupled to the third shunt transmission line and being electrically coupled to the fourth shunt transmission line.

The second primary transmission line can mirror the first primary transmission line, the first shunt transmission line can mirror the second shunt transmission line, and can mirror the third shunt transmission line, the fourth shunt transmission line can mirror the second shunt transmission line, and can mirror the third shunt transmission line, and the first section can mirror the second section.

The first primary transmission line can include a stepped impedance transformation in which the first outer impedance transformer has a first impedance, the first inner impedance transformer has a second impedance, the first central impedance transformer has a third impedance, the second inner impedance transformer has the second impedance, and the second outer impedance transformer has the first impedance; the first impedance can be different from the second impedance, the first impedance can be different from the third impedance, and the second impedance can be different from the third impedance.

As can be seen, the technology described herein is directed to a wideband quadrature coupler based in part on branch-line theory with impedance matching. The wideband quadrature coupler includes two additional metal layers utilized to enhance desired coupling between ports. The two additional metal layers also contribute to mitigating unwanted parasitic capacitance by designed routing. Further, the stepped impedance transformation in the primary branch enhances the usable bandwidth.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As used in this application, the terms “component,” “system,” “platform,” “layer,” “selector,” “interface,” and the like are intended to refer to a computer-related resource or an entity related to an operational apparatus with one or more specific functionalities, wherein the entity can be either hardware, a combination of hardware and software, software, or software in execution. As an example, a component can be an apparatus with specific functionality provided by mechanical parts operated by electric or electronic circuitry. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. A quadrature coupler, comprising:
a first radio frequency (RF) port, a second RF port, a third RF port, and a fourth RF port,
an upper metal layer, a lower metal layer, and a middle metal layer between the upper metal layer and the lower metal layer;
a first set of interconnects that couple the first metal layer to the second metal layer; and
a second set of interconnects that couple the second metal layer to the third metal layer;
wherein the upper metal layer is configured with respective primary transmission lines comprising a respective first primary transmission line between the first RF port and the fourth RF port, and a respective second primary transmission line between the second RF port and the third RF port, the respective primary transmission lines comprising:
respective first RF impedance transformers having respective first impedances, respective second RF impedance transformers having respective second impedances, respective third RF impedance transformers having respective third impedances, respective fourth RF impedance transformers having respective fourth impedances, and respective fifth RF impedance transformers having respective fifth impedances, wherein the respective second RF impedance transformers are between the respective first RF impedance transformers and the respective third RF impedance transformers, and wherein the respective fourth RF impedance transformers are between the respective third RF impedance transformers and the respective fifth RF impedance transformers,
wherein the middle metal layer is configured with respective shunt transmission lines comprising a first shunt transmission line, a second shunt transmission line, a third shunt transmission line, and a fourth shunt transmission line,
wherein the first shunt transmission line is coupled to the respective first primary transmission line via a first interconnect of the first set of interconnects, wherein the second shunt transmission line is coupled to the respective first primary transmission line via a second interconnect of the first set of interconnects, wherein the third shunt transmission line is coupled to the respective second primary transmission line via a third interconnect of the first set of interconnects, and wherein the fourth shunt transmission line is coupled to the respective second primary transmission line via fourth interconnect of the first set of interconnects,
wherein the lower metal layer is configured with respective sections comprising a first section and a second section,
wherein the first section is coupled to the first shunt transmission line via a fifth interconnect of the second set of interconnects, wherein the first section is coupled to the second shunt transmission line via a sixth interconnect of the second set of interconnects, wherein the second section is coupled to the third shunt transmission line via a seventh interconnect of the second set of interconnects, and wherein the second section is coupled to the fourth shunt transmission line via an eighth interconnect of the second set of interconnects, and
wherein the first shunt transmission line is RF coupled to the second shunt transmission line, and electrically coupled to the second shunt transmission line via the first section, to result in a first shunt impedance between the first primary transmission line and the second primary transmission line, and wherein the third shunt transmission line is RF coupled to the fourth shunt transmission line, and electrically coupled to the fourth shunt transmission line via the second section, to result in a second shunt impedance between the first primary transmission line and the second primary transmission line.

2. The quadrature coupler of claim 1, wherein the first impedance equals the fifth impedance.

3. The quadrature coupler of claim 1, wherein the second impedance equals the fourth impedance.

4. The quadrature coupler of claim 1, wherein the first impedance equals the fifth impedance, and the second impedance equals the fourth impedance.

5. The quadrature coupler of claim 1, wherein the first shunt impedance equals the second shunt impedance.

6. The quadrature coupler of claim 1, wherein the respective first primary transmission line is configured in a serpentine pattern in which the respective first impedance transformer and the respective second impedance transformer are above and RF coupled to the first shunt transmission line, and in which the respective fourth impedance transformer and the respective fifth impedance transformer are above and RF coupled to the second shunt transmission line.

7. The quadrature coupler of claim 1, wherein the first interconnect of the first set of interconnects couples the respective first primary transmission line of the respective primary transmission lines to the first shunt transmission line between the respective second impedance transformer and the respective third impedance transformer of the respective first primary transmission line, wherein the second interconnect of the first set of interconnects couples the respective first primary transmission line to the third shunt transmission line between the respective third impedance transformer and the respective fourth impedance transformer of the respective first primary transmission line, wherein the third interconnect of the first set of interconnects couples the respective second primary transmission line to the second shunt transmission line between the respective second impedance transformer and the respective third impedance transformer of the respective second primary transmission line, and wherein the fourth interconnect of the first set of interconnects couples the respective second primary transmission line to the fourth shunt transmission line between the respective third impedance transformer and the respective fourth impedance transformer of the respective second primary transmission line.

8. The quadrature coupler of claim 1, wherein the respective third impedance of the respective first primary transmission line, the respective third impedance of the respective second primary transmission line, the first shunt impedance, and the second shunt impedance correspond to a branch-line ring configuration.

9. The quadrature coupler of claim 1, wherein the respective first impedance transformer of the respective first primary transmission line is narrower than the respective second impedance transformer of the respective first primary transmission line, wherein the respective second impedance transformer of the respective first primary transmission line is narrower than the respective third impedance transformer of the respective first primary transmission line, and wherein the respective first primary transmission line comprises a first tapered portion that couples the respective first impedance transformer to the respective second impedance transformer, and a second tapered portion that couples the respective second impedance transformer to the respective third impedance transformer.

10. The quadrature coupler of claim 1, wherein the respective first impedance transformer of the respective first primary transmission line comprises a first serpentine curve having a first height, and a second serpentine curve having a second height that is less than the first height, wherein the respective second impedance transformer of the respective first primary transmission line comprises a third serpentine curve having a third height that is less than the second height, wherein the respective third impedance transformer of the respective first primary transmission line comprises a fourth serpentine curve having a fourth height that is less than the third height, and wherein a combined impedance of the respective first primary transmission line is based on a first difference between the first height and the second height, a second difference between the second height and the third height, and a third difference between the third height and the fourth height.

11. The quadrature coupler of claim 1, wherein the second primary transmission line is configured to mirror the first primary transmission line, wherein the first shunt transmission line is configured to mirror the second shunt transmission line, and to mirror the third shunt transmission line, wherein the fourth shunt transmission line is configured to mirror the second shunt transmission line, and to mirror the third shunt transmission line, and wherein the first section is configured to mirror the second section.

12. A quadrature coupler, comprising:
an upper metal layer comprising a first primary transmission line between a first radio frequency (RF) port and a fourth RF port, and a second primary transmission line between a second RF port and a third RF port;
a middle metal layer comprising shunt transmission lines electrically coupled to the upper metal layer, and RF coupled to the upper metal layer, the shunt transmission lines configured to RF couple the first primary transmission line to the second primary transmission line; and
a lower metal layer comprising sections electrically coupled to the middle metal layer, and RF coupled to the middle metal layer, the shunt transmission lines configured to electrically couple the first primary transmission line to the second primary transmission line via the sections of the lower metal layer;
wherein a first portion of the first primary transmission line corresponds to a first impedance, a second portion of the second primary transmission line corresponds to the first impedance, a first set of the shunt transmission lines corresponds to a second impedance, and a second set of the shunt transmission lines corresponds to the second impedance,
wherein the first impedance of the first primary transmission line, the first impedance of the second primary transmission line, the second impedance of the first set of the shunt transmission lines, and the second impedance of the second set of the shunt transmission lines correspond to a branch-line ring configuration that outputs an RF signal obtained at the first port to the fourth RF port, and outputs a phase-shifted instance of the RF signal obtained at the first port to the third RF port.

13. The quadrature coupler of claim 12, wherein the shunt transmission lines are electrically coupled to the upper metal layer via a first set of interconnects, and wherein the lower metal layer is electrically coupled to the middle metal layer via a second set of interconnects.

14. The quadrature coupler of claim 12, wherein the first primary transmission line is configured in a serpentine shape of impedance transformers configured as curved portions of the serpentine shape, wherein the first portion of the first primary transmission line comprises a central impedance transformer, and wherein the first primary transmission line comprises a first outer impedance transformer coupled to the first RF port, a second outer impedance transformer coupled to the fourth RF port, a first inner impedance transformer coupled between the first outer impedance transformer and the central impedance transformer, and a second inner impedance transformer coupled between the central impedance transformer and the first outer impedance transformer.

15. The quadrature coupler of claim 14, wherein the first outer impedance transformer has a first width, wherein the first inner impedance transformer has a second width that is different from the first width, wherein the central impedance transformer has a third width that is different from the second width, wherein the first outer impedance transformer is electrically coupled to the first inner impedance transformer by a first tapered coupling, and wherein the first inner impedance transformer is electrically coupled to the central impedance transformer by a second tapered coupling.

16. The quadrature coupler of claim 14, wherein the first outer impedance transformer has a first line length, wherein the first inner impedance transformer has a second line length that is different from the first line length, wherein the central impedance transformer has a third line length that is different from the second line length, and wherein a combined impedance of the first primary transmission line is based on a first difference between the first line length and the second line length, and a second difference between the second line length and the third line length.

17. The quadrature coupler of claim 12, wherein the serpentine shape is a first serpentine shape, wherein the first set of the shunt transmission lines comprises a first part of the middle metal layer configured in a second serpentine shape that overlaps the first outer impedance transformer and the first inner impedance transformer, wherein the sections of the lower metal layer comprise a first section and a second section, and wherein the second serpentine shape overlaps at least part of the first section of the lower metal layer.

18. A device, comprising:
a wideband quadrature coupler configured to output a radio frequency (RF) signal obtained at a first RF port to a fourth RF port, and output a phase shifted instance of the RF signal to a third RF port, the wideband quadrature coupler comprising:
a first primary transmission line on a first metal layer, the first primary transmission line comprising a first outer impedance transformer coupled to the first RF port, a first inner impedance transformer, a first central impedance transformer, a second inner impedance transformer, and a second outer impedance transformer coupled to the fourth RF port, wherein the first inner impedance transformer is electrically coupled between the first outer impedance transformer and the first central impedance transformer, and wherein the second inner impedance transformer is electrically coupled between the first central impedance transformer and the second outer impedance transformer;
a second primary transmission line on the first metal layer, the second primary transmission line comprising a third outer impedance transformer coupled to a second RF port, a third inner impedance transformer, a second central impedance transformer, a fourth inner impedance transformer, and a fourth outer impedance transformer coupled to the third RF port, wherein the third inner impedance transformer is electrically coupled between the third outer impedance transformer and the second central impedance transformer, and wherein the fourth inner impedance transformer is electrically coupled between the second central impedance transformer and the fourth outer impedance transformer;
a second metal layer comprising:
a first shunt transmission line electrically coupled between the first inner impedance transformer and the first central impedance transformer, and RF coupled to the first outer impedance transformer and the first inner impedance transformer;
a second shunt transmission line electrically coupled between the first central impedance transformer and the second inner impedance transformer, and RF coupled to the second inner impedance transformer and the second outer impedance transformer;
a third shunt transmission line electrically coupled between the third inner impedance transformer and the second central impedance transformer, and RF coupled to the third outer impedance transformer and the third inner impedance transformer; and
a fourth shunt transmission line electrically coupled between the second central impedance transformer and the fourth inner impedance transformer, and RF coupled to the fourth outer impedance transformer and the fourth outer inner impedance transformer; and
a third metal layer comprising:
a first section electrically coupled between the first shunt transmission line and the second shunt transmission line, wherein the first section is RF coupled to the first shunt transmission line, and RF coupled to the third shunt transmission line; and
a second section electrically coupled between the third shunt transmission line and the fourth shunt transmission line, wherein the first section is RF coupled to the second shunt transmission line, and RF coupled to the fourth shunt transmission line,
wherein the first primary transmission line is electrically coupled to the second primary transmission line via the first section being electrically coupled to the first shunt transmission line and being electrically coupled to the second shunt transmission line, and via the second section being electrically coupled to the third shunt transmission line and being electrically coupled to the fourth shunt transmission line.

19. The device of claim 18, wherein the second primary transmission line mirrors the first primary transmission line, wherein the first shunt transmission line mirrors the second shunt transmission line, and mirrors the third shunt transmission line, wherein the fourth shunt transmission line mirrors the second shunt transmission line, and mirrors the third shunt transmission line, and wherein the first section mirrors the second section.

20. The device of claim 18, wherein the first primary transmission line comprises a stepped impedance transformation in which:
the first outer impedance transformer has a first impedance;
the first inner impedance transformer has a second impedance;
the first central impedance transformer has a third impedance;
the second inner impedance transformer has the second impedance; and
the second outer impedance transformer has the first impedance, and
wherein the first impedance is different from the second impedance, the first impedance is different from the third impedance, and the second impedance is different from the third impedance.
